(19) United States
(12) Patent Application Publication
(10) Pub. No.: US 2007/0009415 A1
(43) Pub. Date: Jan. 11, 2007

(54) Mixed metal oxides and use thereof in co2 sensors

(76) Inventors: Stefan Faber, Saarbruecken (DE); Sanjay Mathur, Saarbruecken (DE); Ralph Nonninger, Saarbruecken (DE); Frank Meyer, Saarbruecken (DE); Michael Veith, St. Ingbert (DE); Hao Shen, Saarbruecken (DE)

Correspondence Address: FLYNN THIEL BOUTELL & TANIS, P.C., 2026 RAMBLING ROAD, KALAMAZOO, MI, 49008-1631, US

(21) Appl. No.: 10/561,624

(22) PCT Filed: Jun. 25, 2004
(86) PCT No.: PCT/EP04/06938

§ 371 Date: May 15, 2006

(30) Foreign Application Priority Data
Jun. 25, 2003 (DE) 103 29 626.3

(51) Int. Cl. C01F 17/00

(52) U.S. Cl. 423/263; 423/593.1

(57) ABSTRACT

The invention relates to novel mixed metal oxides of the formula AXO₃ and to mixtures of such mixed metal oxides. The particle size of the inventive substances is preferably in the nanoscale region, i.e. well into the sub-μm range. The novel compounds can be used in particular for the detection of gases, in particular of incombustible gases such as CO₂.

The invention relates to novel mixed metal oxides and to their preparation and use.

CO₂ sensors serve for fire or explosion protection, for process monitoring in industrial plants or are used in sensor arrays as “chemical noses”. Moreover, CO₂ sensors are finding an ever wider field of application for measuring atmospheric air quality, automotive exhaust gases or industrial offgases or in the biomonitoring field (brewing processes, fouling, fermentation, respiration, etc.) or in climate-control units.

For incombustible, i.e. unoxidizable, gases such as CO₂, there are currently two different measurement principles:

These are firstly optical methods by means of NDIR (nondispersive infrared absorption). This method detects the CO₂ absorption band at 4.27 μm and features high sensitivity. It is very costly and inconvenient, since complicated optics are required in conjunction with precision mechanics (spectrometer). Even in the future, such sensors will also not find wide use in mass markets in which simple and inexpensive construction is important.

Secondly there are electrochemical sensors in which a potential difference between measurement electrode and encapsulated reference electrode is detected in the event of adsorption of gas molecules. Such sensors are costly and inconvenient, and suffer from a long response time (up to 30 seconds), cross-sensitivity toward atmospheric moisture and fault-prone construction. A special case of such electrochemical CO₂ sensors is found on the basis of sodium ion-conducting solid electrolytes with an alkali metal carbonate electrode. These are known as NASICON sensors (Na super-ionic conductor). Owing to their moisture sensitivity, such systems have to be substantially encapsulated and have a long response time, but have long-term stability and are sensitive.

Since both methods are very costly, another measurement principle for CO₂ detection has been sought. Materials with apparent suitability are in particular semiconductive materials which are capable of reversibly adsorbing CO₂ molecules and of reacting with a detectable resistance change in the event of gas adsorption. Such a process should be realizable inexpensively in the case of application of the semiconductor as a thin layer on a support material.

To date, only doped SnO₂ has been investigated as a semiconductive, gas-sensitive material [Tamaki, Akiyama, Xu, Chemistry Letters (1990), 1243; Wei, Luo, Liao et al. J. Appl. Phys. (2000), 88, 4818]. However, it is unsuitable for selective CO₂ detection since the detection limit is too high and the cross-sensitivity to oxidizable gases (in particular to CO and H₂) cannot be suppressed [Delabie, Honore, Lenaerts et al., Sensors and Actuators B, (1997), 44, 446]. In addition, the homogeneity of the doping cannot be ensured, which leads to irreproducible measurements [Kim, Yoon, Park et al., Sensors and Actuators B (2000), 62, 61].

Nanoscale materials have been investigated for CO₂ detection only in one case and are restricted to BaTiO₃ which has been doped with various materials such as CuO, CaCO₃ or La₂O₃ [DE 4437692 A1 to the Fraunhofer-Gesellschaft]. This material is synthesized in a complicated manner by laser ablation or ball grinding, which brings great disadvantages: in addition to the high level of complexity, particle aggregation caused by the process greatly restricts the effective surface area of the material as a result of agglomeration of the individual crystals. Moreover, the dopants are not distributed homogeneously and tend to migrate the particle edges in the course of sintering. Furthermore, it is not possible with the process mentioned to prepare monodisperse particles, which leads to larger particles being present alongside smaller particles, which, owing to their different surface area, react to CO₂ with different sensitivity.

The preparation of nanoparticles by grinding operations in particular has further fundamental disadvantages. For instance, the attritus of the grinding cup and grinding balls is found in the resulting nanomaterial, the time requirement is very large (up to several weeks), the particle size distribution is very broad and the resulting material typically has a very high level of defects, lattice stresses and lattice faults. Materials produced in this way may have catalytic properties or be used as electron conductors. In contrast, they are unusable as sensor material for a gas sensor, since a substantially defect-free, homogeneous, molecularly doped material without lattice faults is required for this purpose.

The aforementioned disadvantages lead to the fact that, on the basis of the known production processes and materials, the sensitivity and selectivity of gas sensors, especially of CO₂ sensors, are in very great need of improvement. A sensor based on known materials is unsuitable for commercial use.

It is thus an object of the invention to develop novel materials. These are to be used in particular in a simple and inexpensive measurement array as a gas sensor with high sensitivity and specificity.

This object is achieved by the mixed metal oxides and mixtures thereof as claimed in claim 1. Preferred embodiments of these oxides are stated in the dependent claims 2 to 18 and also 21 and 22. Claims 19 and 20 encompass particular applications of the inventive mixed metal oxides. Claim 23 claims a sensor which comprises the inventive mixed metal oxides. Finally, claims 24 and 25 show an inventive process for preparing the claimed mixed metal oxides and novel inventive intermediates respectively. The wording of all claims is hereby incorporated in the contents of this description by reference.

For the disclosure of the invention, reference is made at this point explicitly to the formulations of the above claims. In this context, the terms used in the claims will be explained in detail as follows.

The numbering of the groups of the periodic table which is specified in the claims is in the IUPAC version, in which the individual groups of the periodic table are simply numbered serially.

The term “nanoscale” is intended to express that the mean particle size of the mixed metal oxide particles is well within the sub-μm range. This particle size is intended to relate to the individual particles in the non-agglomerated state. Owing to their high surface energies, nanoscale particles frequently combine and in this way form agglomerates or particle clusters which give the impression of a greater particle size than the individual particle actually has. The size data in the invention relate correspondingly, where possible, to the mean particle size of a single particle, which can also be referred to in this context as “primary particle”. As stated in claim 3, the (mean) particle size of the inventive mixed metal oxides is preferably less than 100 nm, in particular less than 50 nm.

The inventive mixed metal oxides are preferably semiconductive materials, the properties of semiconductors being known from the prior art. Such semiconductive materials are (doped or undoped) usable in various ways, in particular as gas sensors, for example for detecting CO₂.

The invention is not restricted to the preparation of the mixed metal oxides by the so-called single-source precursor technique. In the case of various inventive mixed metal oxides, it will be entirely possible to prepare the substances from two or more starting compounds present separately alongside one another, for example alkoxides. The presence of a single such starting compound, for example of such an alkoxide, as a single source is not necessarily required in such cases.

It has been found that doped mixed metal oxides (perovskites) and also metal-metal oxide composites with a dopant are suitable especially for CO₂ detection. However, these substances cannot be prepared directly, since established methods such as precipitation or classical sol-gel chemistry frequently cannot be used. Either there is a lack of suitable reactive precursors or it is necessary, in the case of the sol-gel process in particular, to deal with individual precursors (alkoxides) which feature highly differing reactivities and hydrolysis rates. Simple metal alkoxides can be prepared via organometallic syntheses and have been known for some time. For example, barium isopropoxide can be prepared by boiling barium metal in anhydrous isopropanol under an inert gas atmosphere. Other metal alkoxides such as the propoxides of titanium or zirconium are already available on the industrial scale. However, a mixture of such alkoxides with other alkoxides can, after hydrolysis and workup, lead to a nonuniform structure which is unsuitable, for example, as a CO₂ sensor. For other compositions, the precursors are commercially unavailable. Moreover, for an optimal performance characteristic, homogeneous doping in the preferably low atom % range is needed, which cannot be achieved by these methods.

It has now been found that especially nanoscale, doped barium cerates and barium stannate compounds are suitable as CO₂-sensitive materials, for which it is, however, essential to tailor at the molecular level, which is shown by this patent.

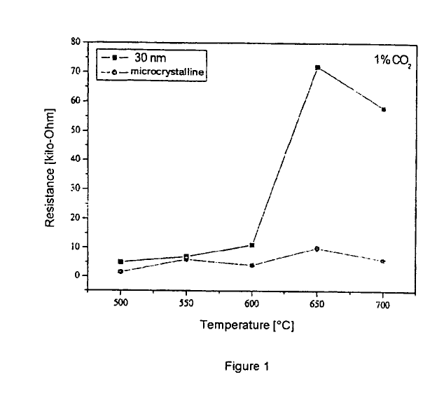

It has now been determined that, surprisingly, especially the single-source precursor technique known for the CVD method [R. C. Mehrotra, Chemtracts: Org. Chem, (1990) 2, 338 or Sing and Mehrotra, Z. Anorg. Allg. Chemie, (1984), 512, 221] is suitable for producing precisely these CO₂-sensitive materials with high homogeneity, both simply and inexpensively. These materials have the desired homogeneous doping and mixing at the molecular level, for which hydrolyzable complex metal alkoxide compounds are used as molecular templates. This single-source process achieves extremely pure compounds doped preferably in the atom % range of from 0.01 to 10%, which possess outstanding gas sensor properties, as shown in FIG. 1. Furthermore, it is possible to realize very small and monodisperse crystal sizes and thus large surface areas, which is very important for the sensitivity of a sensor.

In a particular embodiment of the invention, the alkoxide used, which is commercially unavailable, is self-synthesized.

According to the invention, BaCeO₃, preferably doped, has been identified as the CO₂-sensitive material. It has been possible here for the first time to prepare BaCeO₃ which has been doped homogeneously with Cu and has CO₂-sensitive and selective properties, which extends far beyond the prior art.

The thus obtained material can be deposited by means of screen-printing or pad-printing processes known to those skilled in the art as a layer on a sensor substrate, for example alumina (Al₂O₃), or implemented into commercial sensor platforms (for example from Heraeus). When the (electrical) resistance of the nanoscale doped BaCeO₃ in CO₂ atmosphere is then measured as a function of temperature, a sharp rise in the signal of the sensor is surprisingly observed at 600° C. in FIG. 1. In the case of a microcrystalline BaCeO₃ comparative sample with a very much smaller surface area, such a sharp rise cannot be seen. This means that especially a nanocrystalline material (here: particle size 30 nm) possesses CO₂-sensitive properties.

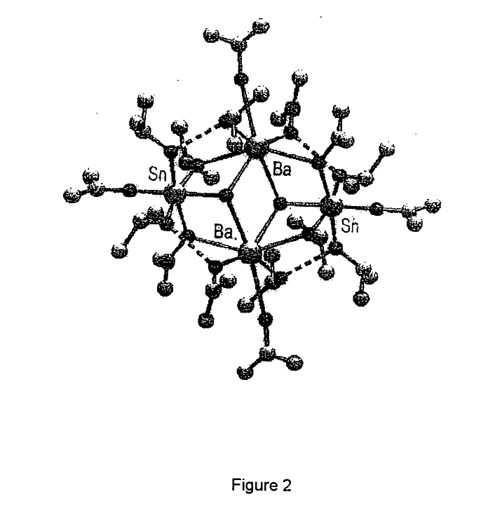

Starting substances for the sensor material are mixed metal alkoxides which, in one molecule, have already predefined the metal-metal ratio at the molecular level (Ba:Ce here 1:1) of the oxide resulting after hydrolysis and are joined to one another by oxygen bridges. Example (FIG. 2: BaSn(OiPr)₈) as a precursor for BaSnO₃). iPr represents isopropyl. It has also been possible to realize more complicated compositions (Ba(Ti,Ce)(OR)₈ for Ba(Ti_{0.5}Ce_{0.5})O₃). R represents alkyl, preferably isopropyl. By way of example, the structure can be seen using a precursor for BaSnO₃ in FIG. 2.

It is of great advantage to predefine the stoichiometry and the structure of the compound resulting after the hydrolysis in the precursor molecule. To this end, the three-dimensional network of the phase-forming elements formed after the hydrolysis of the alkoxides connects all relevant atoms (oxygen and metal) with one another chemically in the correct arrangement. This structure provides the basis for the nanoparticles, which are formed even at low temperatures. The CO₂-sensitive material obtained after workup is doped homogeneously at the mesoscopic level and single-phase, and possesses a virtually monodisperse particle distribution in the nm range. The material can optionally be thermally aftertreated, i.e. crystallized. The substances are either obtained in crystalline form as early as in the hydrolysis or are crystallized in a gentle, hydrothermal manner in the high-pressure autoclave. Compared to a calcination, hydrothermal technology has the advantage of avoiding particle agglomeration and of leaving the surface in the reactive, i.e. modifiable state.

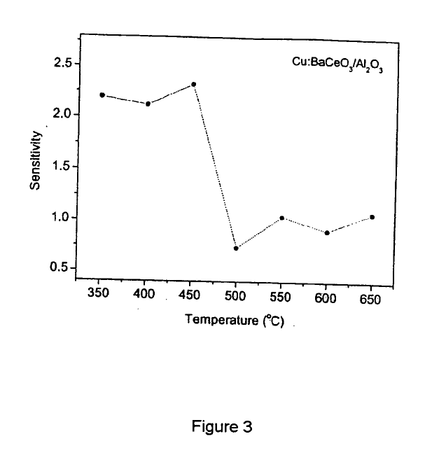

However, an aftertreatment by calcination also results in materials with outstanding CO₂-sensitive properties. FIG. 3, for example, shows the temperature-dependent gas sensitivity of BaCeO₃ doped with 5% copper. The material has been deposited on alumina by means of a spin-coating and/or dip-coating process and is present in the form of a thin film. The material with a mean particle size of 20 nm had been heat-treated at 1000° C. In the low temperature range (from 350° C. to 450° C.), it exhibited a distinctly higher CO₂ sensitivity than in the higher temperature range (from 500 to 650° C).

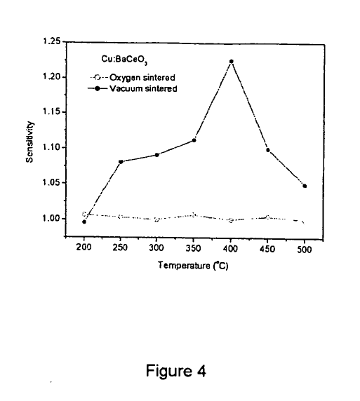

Production processes and also thermal aftertreatment can play a great role in relation to the CO₂ sensitivity of the resulting materials. The thermal aftertreatment allows the surface properties of the materials to be influenced. In the case of aftertreatment by calcination, it has been found that, surprisingly, performance of the thermal aftertreatment under reduced pressure can lead to a great rise in the CO₂ sensitivity. FIG. 4 likewise shows the temperature-dependent gas sensitivity of nanoscale BaCeO₃ doped with 5% copper. Also plotted here is the sensitivity against temperature (° C.), once for a sensor made of material which has been sintered under reduced pressure, and once for a material which has been sintered in the presence of oxygen. The comparison shows clearly that the sintering under reduced pressure leads to distinctly higher sensitivity than the comparable sintering in the presence of oxygen.

The process described is inexpensive, capable of being scaled-up and reproducible. It is possible to dope different metals in a controlled manner into a carrier matrix, for which no other process known in the literature is suitable. The sensor is extremely sensitive, specific (no cross-sensitivity to water or CO) and has a very low operating temperature, which has a positive effect on the stability and thus the operating time.

### 1. EXAMPLE OF BaCeO₃ WITH COPPER DOPING

8.506 g of Ba(O^{t}Bu)₂ (0.03 mol) (^{t}Bu represents tert-butyl) are suspended in absolute PrⁱOH (200 ml) (Prⁱ and ⁱPr represent isopropyl), and a stoichiometric amount of Ce(OⁱPr)₄ (9.827 g, 0.03 mol) is added slowly with stirring under a protective gas atmosphere. The cloudy mixture is stirred for 6 h until a clear solution is obtained. At this time, a mixed Ba—Ce alkoxide has formed, BaCe[(O^{t}Bu)₂(OⁱPr)₄] to be precise, which, in contrast to the original alkoxides, is soluble in PrⁱOH. Subsequently, a doping with a copper source such as CuCl₂ in alcohol or a Cu alkoxide in the desired stoichiometry can be effected. To this end, 0.255 g of CuCl₂ (5 mol %) in 10 ml of isopropanol is added and the mixture is stirred vigorously for 2 h. A transparent green sol is obtained. The doped Ba—Ce alkoxide sol is mixed with a stoichiometric amount of a 1.0 molar water solution in isopropanol with vigorous stirring. The still-clear sol is concentrated on a rotary evaporator at bath temperature 45° C. The concentrated BaCeO₃ sol is then freeze-dried or freed of residual moisture in a drying cabinet at 120° C. After the organic constituents have been pyrolyzed in a muffle furnace at 400° C., the material is crystallized at 1000° C. for 2 h. The thus obtained material can be deposited as a layer on a sensor substrate (Al₂O₃) by means of screen-printing or pad-printing processes known to those skilled in the art or implemented into commercial sensor platforms (for example from Heraeus).

### 2. EXAMPLE OF BaCeO₃ WITH COPPER DOPING

8.506 g of Ba(O^{t}Bu)₂ (0.03 mol) are suspended in absolute PrⁱOH (200 ml), and a stoichiometric amount of Ce(OⁱPr)₄ (9.827 g, 0.03 mol) is added slowly with stirring under a protective gas atmosphere. The cloudy mixture is stirred for 6 h until a clear solution is obtained. At this time, a mixed Ba—Ce alkoxide has formed, BaCe[(O^{t}Bu)₂(OⁱPr)₄] to be precise, which, in contrast to the original alkoxides, is soluble in PrⁱOH. Subsequently, a doping with a copper source such as CuCl₂ in alcohol or a Cu alkoxide in the desired stoichiometry can be effected. To this end, 0.255 g of CuCl₂ (5 mol %) in 10 ml of isopropanol is added and the mixture is stirred vigorously for 2 h. A transparent green sol is obtained. The doped Ba—Ce alkoxide sol is mixed with a stoichiometric amount of a 1.0 molar water solution in isopropanol with vigorous stirring. The still-clear sol is concentrated on a rotary evaporator at bath temperature 45° C. 110 g of such Cu-doped hydrolyzed BaCeO₃ sol (solids content: 10%) are autoclaved at 250° C. for 6 h in a 250 ml stirred autoclave within a Teflon vessel at an internal pressure of 50 bar. After cooling, a white powder is obtained and is washed repeatedly with alcohol and water. X-ray diffractometry reveals single-phase BaCeO₃ with small traces of CuO.

Instead of Cu-doped BaCeO₃, a series of other nanomaterials are suitable as CO₂ sensor material. These include, instead of Ce, elements of group 4, 7, 13 and 14, in particular Ce, Ti, Zr, In, Sn, Mn, and also mixtures of two or more elements therefrom.

Instead of Ba, it is also possible to use elements of group 1, 2 and 3, in particular Li, Mg, Ca, Sr, Ba, Y and La, and also mixtures of two or more elements therefrom.

The dopings are between 0.01 and 20 atom %, in particular between 0.1 and 10%, very particularly between 1 and 6%.

Nanoscale means primary particles <150 nm, very particularly <100 nm, specifically <50 nm.

In addition to Cu, suitable doping ions are: elements of the lanthanides, in particular: Pr, Nd, Sm, Eu, Gd, La, Er, etc., and also mixtures of two or more elements therefrom, and also elements of group 3, 10, 11, 12 and 13, in particular In, Ga, Zn, Co, Ni, Cu, Ag, Au, Pt or Pd, and also mixtures of two or more elements therefrom.

In another particular embodiment, metal/metal composite combinations are produced, preferably by means of the single-source precursor technique. To this end, organometallic precursors, as in the above-described examples, are decomposed, but in such a way that not only metal oxides but also elemental metals in a metal oxide matrix can form. These ternary composites are useable as gas-sensitive, in particular as CO₂-sensitive materials. This is because the elemental metals introduce additional charge carriers into the system, which improves the conductivity of the semiconductive base material such that the overall composite reacts very sensitively to CO₂, for example. The precursor molecule provides the template for submicroscopic mixing of the individual components.

In the case of a Cu/Al₂O₃ composite, the starting material is a precursor for CuAl₂O₄, for example Cu[Al₂(OⁱPr)₈]. The hydrolyzate of such a precursor decomposes thermally under reducing conditions to give a homogeneous nanoscale Cu/Al₂O₃ composite. When the reducing atmosphere is varied, CuO/Al₂O₃ or Cu₂O/Al₂O₃ composites or mixtures of Cu/Cu₂O/CuO in an Al₂O₃ matrix are formed.

Further single-source composite compounds preparable by the method described or other methods include Cu or Cu₂O or CuO in a TiO₂ matrix, or Sn, Cu or Cu₂O or CuO in an SnO₂ matrix.

Suitable further matrix materials are ZrO₂, CeO₂, Fe₂O₃, SiO₂ and Y₂O₃.

Suitable metals or, if appropriate, metal oxides in the matrix are, in addition to Cu or Sn, elements of the lanthanides, in particular: Pr, Nd, Sm, Eu, Gd, La, Er, etc., and also mixtures of two or more elements therefrom, and also elements of group 3, 8, 9, 10, 11, 12 and 13, in particular In, Ga, Zn, Co, Ni, Ru, Os, Rh, Ir, Cu, Ag, Au, Pt or Pd, and also mixtures of two or more elements therefrom.

1. A mixed metal oxide of the formula AXO₃ where
A is at least one element selected from the elements of group 1, 2 and 3 of the periodic table,
X is at least one element selected from the elements cerium (Ce) and the elements of group 4, 7, 13 and 14 of the periodic table,
and mixtures of such mixed metal oxides.

2. The mixed metal oxide as claimed in claim 1, wherein the particle size of the mixed metal oxide is in the nanoscale range.

3. The mixed metal oxide as claimed in claim 2, wherein the particle size of the mixed metal oxide is <100 nm, preferably <50 nm.

4. The mixed metal oxide as claimed in claim 1, wherein the mixed metal oxide is doped.

5. The mixed metal oxide as claimed in claim 4, wherein at least one element selected from the elements of group 3, 10, 11, 12 and 13 of the periodic table and the lanthanoids is present for doping.

6. The mixed metal oxide as claimed in claim 4, wherein the doping element is copper.

7. The mixed metal oxide as claimed in claim 4, wherein the content of doping elements is between 0.01 and 20 atom %, preferably between 0.1 and 10 atom %, in particular between 1 and 6 atom %.

8. The mixed metal oxide as claimed in claim 1, wherein A is selected from the elements of group 2 of the periodic table, and is preferably barium (Ba).

9. The mixed metal oxide as claimed in claim 1, wherein A is lithium (Li).

10. The mixed metal oxide as claimed in claim 1, wherein A is lanthanum (La) or Yttrium (Y).

11. The mixed metal oxide as claimed in claim 1, wherein X is cerium (Ce).

12. The mixed metal oxide as claimed in claim 1, wherein X is titanium (Ti) or zirconium (Zr).

13. The mixed metal oxide as claimed in claim 1, wherein X is manganese (Mn).

14. The mixed metal oxide as claimed in claim 1, wherein X is indium (In).

15. The mixed metal oxide as claimed in claim 1, wherein X is tin (Sn).

16. The mixed metal oxide as claimed in claim 1, with the formula BaXO₃ where X is cerium (Ce).

17. The mixed metal oxide as claimed in claim 16, wherein the mixed metal oxide is doped, the doping element preferably being copper.

18. The mixed metal oxide as claimed in claim 1 preparable by the so-called single-source precursor technique.

19. The method for detecting gases, preferably for detecting incombustible gases, wherein the mixed metal oxides as claimed in claim 1 are used.

20. The method as claimed in claim 19, wherein the detected gas is carbon dioxide (CO₂).

21. The mixed metal oxide as claimed in claim 1 being applied to a substrate or incorporated into a substrate.

22. The mixed metal oxide as claimed in claim 21, wherein the substrate is a substrate for sensors, in particular for gas sensors.

23. A sensor, preferably sensor for the detection of gases, comprising a mixed metal oxide as claimed in claim 1, preferably being coated with a mixed metal oxide as claimed in claim 1.

24. A process for preparing mixed metal oxides as claimed in claim 1, wherein a mixed metal alkoxide whose stoichiometry and structure are adjusted to the mixed metal oxide to be prepared is prepared with the aid of the so-called single-source precursor technique, and this mixed metal alkoxide, optionally after a doping step, is hydrolyzed to the mixed metal oxide.

25. A mixed metal alkoxide as an isolated intermediate in the process as claimed in claim 24.
